(19) United States
(12) Patent Application Publication
(10) Pub. No.: US 2012/0136803 A1
(43) Pub. Date: May 31, 2012

(54) Commodity Currency Portfolio And Index

(76) Inventor: Ronald L. Leven, New York, NY (US)

(21) Appl. No.: 12/954,966

(22) Filed: Nov. 29, 2010

(51) Int. Cl. G06Q 40/00

(52) U.S. Cl. 705/36 R

(57) ABSTRACT

A computerized method involves determining a first currency weighting factor for a group of net commodity exporting countries as a function of individual country net commodity trade information relative to individual country GDP information, determining a second currency weighting factor for the individual country based upon GDP information relative to total GDP information for the group, determining a third currency weighting factor for the individual countries based correlation to the Commodity Research Board index, and calculating, for each of the individual countries, a currency weight factor as an average of the first, second and third currency weighting factors, wherein the currency weighting factors for the group collectively defines a currency portfolio that is a proxy for at least some commodities exported by the countries of the group.

### FIELD OF THE INVENTION

This application generally relates to computerized analysis in the area of international finance and, more particularly, to computerized analysis involving currencies of countries whose economies are strongly correlated with commodity price fluctuations.

### BACKGROUND

The relationship between commodities and currencies is well established. It is so well established that, due to the heavy commodity component to their net export flows and the effect on currency value, certain currencies are generally referred to as “commodity currencies.”

However, because of the dollar pricing convention used in international commodity markets, there is an inherent dollar bias in those markets. For example, when the Euro (EUR) rallies against the U.S. dollar (USD) copper prices become cheaper in EUR terms. In turn, this stimulates demand, which pushes USD prices higher. As a consequence of this dollar bias, there is a strong, ongoing inverse link between general USD performance and commodity performance. In general, commodity up-trends are associated with a declining U.S. dollar and vice versa. The dollar bias also means that some currencies, especially the EUR, have a high correlation with commodity prices, despite being commodity importing regions.

In addition, in general, when it comes to building a portfolio of commodity currencies or specifying an index of such currencies, correlation is the major basis for selecting and weighting commodity currencies. However, relying so heavily of correlations can produce erratic results. Moreover, in times of unusual volatility, reliance upon correlation, given the dollar bias, is a problem.

### SUMMARY

The approach described herein is designed to allow for creation of a portfolio and/or commodity currency index that will be a valid proxy or surrogate for, or a tradable indicator of, general macro performance of commodities in the global economy that minimizes or neutralizes the inherent dollar bias implicit in being long commodities. The approach has different aspects.

One aspect involves a computerized method including determining, using a processor, a first currency weighting factor for each individual country in a group of net commodity exporting countries as a function of individual country net commodity trade information, obtained from storage associated with the processor, relative to individual country GDP information, determining, using the processor, a second currency weighting factor for each individual country based upon its GDP information, obtained from the storage, relative to total GDP information for the group, determining, using the processor, a third currency weighting factor for each of the individual countries based correlation to the Commodity Research Board index, and calculating, for each of the individual countries, using the processor, a currency weight factor as an average of the first currency weighting factor, second currency weighting factor and third currency weighting factor, wherein the calculated currency weight factors for the group collectively defines a currency portfolio that is a proxy for at least some commodities exported by the countries of the group.

Another aspect involves an apparatus for generating a commodity currency index. The apparatus has a currency transaction data processing system including at least one processor and storage, accessible by the processor, the storage including instructions which when executed by the at least one processor will cause the currency transaction data processing system to repeatedly: multiply spot rates for a defined group of currencies of individual net commodity exporting countries by currency weight factors for each member of the defined group, the currency weight factors having been obtained from the storage and having been previously calculated as an average of at least three factors, wherein one of the at least three factors involves a comparison of individual country net commodity trade information relative to individual country GDP information, in order to generate current weighted commodity currency values for each of the currencies in the defined group, normalize the current weighted regional currency values to obtain normalized commodity currency values, and generate the commodity currency index as an average of the normalized currency values.

Another aspect involves an apparatus having a processor, storage, accessible by the processor, first programming in the storage, executable by the processor, to compute country-specific factors for a set of net commodity exporting countries, on an individual country basis, based upon at least individual country net commodity trade information relative to individual country GDP information and individual country GDP information relative to total GDP information for the set of net commodity exporting countries, second programming in the storage, executable by the processor, to compute country-specific weightings based upon a combination of the country specific factors for each of net commodity exporting countries in the set, on an individual country basis, and store results of the computation as a set of weightings for the countries in the set, and third programming in the storage, executable by the processor, comprising an index generation module configured to convert the set of weightings and individual spot currency prices for the specific currencies into a commodity currency index, publish the commodity currency index, and periodically update the commodity currency index.

A further aspect involves a computer readable medium having instructions stored thereon which, when executed by a computing device, cause the computing device to: determine a first currency weighting factor for each individual country of a group of net commodity exporting countries based upon individual country net commodity trade information relative to individual country GDP information, determine a second currency weighting factor for the individual countries in the group based upon individual country GDP information relative to total GDP information for the group, determine a third currency weighting factor for the individual countries in the group based upon correlation between each individual country in the group's currency and the CRB index, and calculate a currency weight factor for each of the individual countries as an average of the first currency weighting factor, second currency weighting factor and third currency weighting factor.

The advantages and features described herein are a few of the many advantages and features available from representative embodiments and are presented only to assist in understanding the invention. It should be understood that they are not to be considered limitations on the invention as defined by the claims, or limitations on equivalents to the claims. For instance, some of these advantages are mutually contradictory, in that they cannot be simultaneously present in a single embodiment. Similarly, some advantages are applicable to one aspect of the invention, and inapplicable to others. Thus, this summary of features and advantages should not be considered dispositive in determining equivalence. Additional features and advantages of the invention will become apparent in the following description, from the drawings, and from the claims.

### BRIEF DESCRIPTION OF THE DRAWINGS

FIG. 1 illustrates, in simplified fashion, example configurations suitable for use with, and containing, an apparatus according to the present claims;

FIG. 2 is a chart showing net trade in commodities as a % of GDP for certain developed countries, on average for the five years ending 2005, based upon the International Trade Centre's disaggregated trade data;

FIG. 3 illustrates, in simplified fashion, the general process flow for the CF factor calculation;

FIG. 4 illustrates, in simplified fashion, the general process flow for the GE factor calculation;

FIG. 5 illustrates, in simplified fashion, the general process flow for the COR factor calculation;

FIG. 6 illustrates, in simplified fashion, the general process flow for the overall weighting determination; and

FIG. 7 illustrates, in simplified fashion, a flow diagram for constructing an index using the weights.

### DETAILED DESCRIPTION

In simplified overview, the approach constructs a basket of commodity currencies that minimizes or neutralizes inherent dollar bias by using a combination of three weighting factors that take into account (1) relative size of the ratio of net commodity trade to GDP, (2) relative importance of each country in the global economy, and (3) relative correlation with the Commodity Research Bureau (“CRB”) index. The resultant basket can be used as a portfolio for direct or managed investment in the currencies, as a proxy for investment in the underlying commodities. Additionally, or alternatively, the approach can be used to create a commodity currency index based upon the above factors. Advantageously, the approach also allows creation of financial instruments, including exchange traded funds, exchange traded notes, and various other types of instruments that mirror, or are linked to the performance of, the portfolio or index. Moreover, the approach can provide a way to arbitrage against the CRB index itself.

The approach creates a basket that is long commodity exporters, with the short restricted to the U.S. dollar. Another way to look at this is, a non-dollar based investor in commodities is implicitly long dollars simply because of how commodities are denominated. By making the basket long the commodity linked currencies and short the U.S. dollar, the basket effectively creates an opportunity to invest in commodities that minimizes or neutralizes the inherent long dollar position.

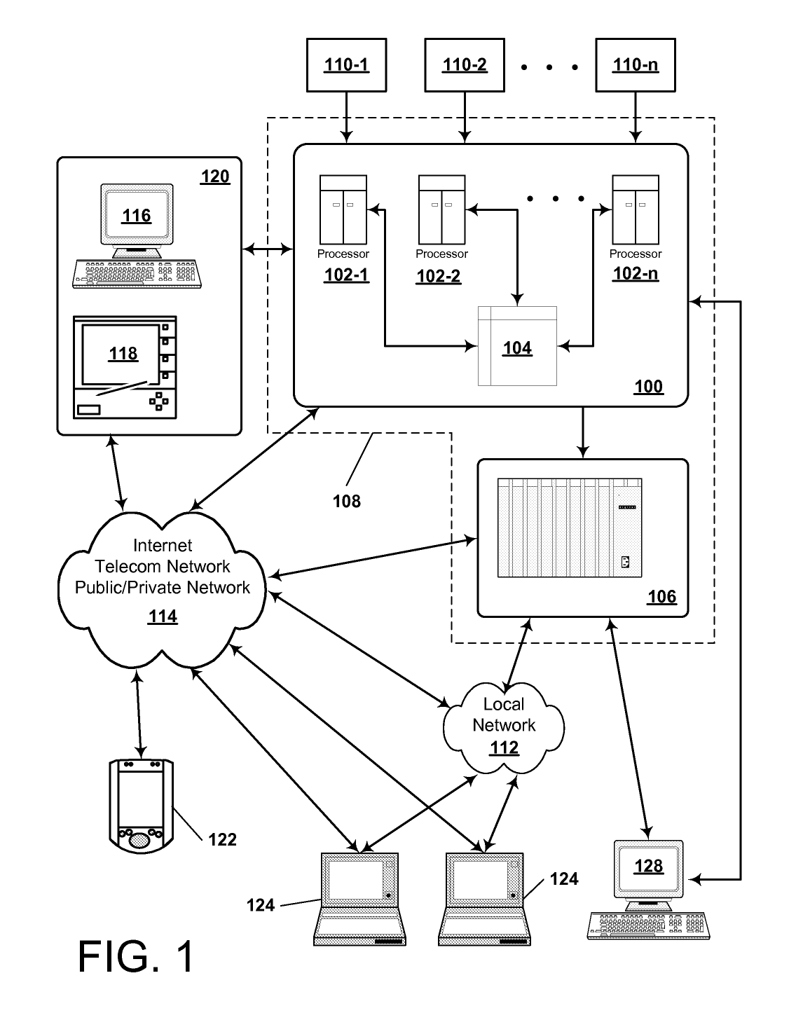

In the above regard, FIG. 1 illustrates, in simplified fashion, example configurations suitable for use with, and containing, an apparatus according to the present claims. Specifically, the approach is implemented as a computerized approach in which a currency analysis processing system (100) is constructed that is made up of at least one, and possibly more, processors (102-1, 102-2, . . . 102-n) and storage (104), accessible by the processor(s) which itself may be made up of various storage devices such as random access memory (“RAM”), read only memory (“ROM”), solid state memory, disk drives, or any other storage device capable of holding data and/or program code to effect the approaches referred to herein.

The currency analysis processing system (100) is configured such that one or more of the processor(s) (102-1, 102-2, . . . 102-n) operating under control of the program code, specifying desired program flow, can receive information and access the storage to implement one or more of the variant approaches described in greater detail herein.

Depending upon the particular variant and implementation, the currency analysis processing system (100) can be coupled to, or optionally itself contain, an exchange system (106) such that the currency analysis processing system (100) alone, or in conjunction with the exchange system (106), will function as a currency transaction data processing system (108). The exchange system (106), if not implemented as part of the currency analysis processing system (100) will itself contain processing and storage capability that can be constructed and used in a conventional way an exchange for financial instruments can be constructed so as to enable it to receive bids and offers for financial instruments and match bids and offers for those financial instruments.

Depending upon the particular variant and implementation, the currency analysis processing system (100) and/or the currency transaction data processing system (108) may also be configured to publish an index, constructed as described herein, for receipt and/or viewing by the relevant audience.

In addition, the currency analysis processing system (100) is configured to receive financial data, using known methods, either directly from the data sources or via third-party sources (110-1, 110-2, . . . , 110-n) such as Bloomberg, Haver Analytics, Thomson, etc. The data can include, for example, data from the Triennial Central Bank Survey of Foreign Exchange and Derivatives Market Activity, data from the International Monetary Fund (“IMF”), currency spot pricing information, and national source or other information regarding the countries and/or currencies of interest.

Depending upon the particular implementation variant and circumstances, the currency analysis processing system (100), the exchange system (106), and/or the currency transaction data processing system (108) can be made accessible to at least one or more of the following via, for example any one or more of, a local network (112) or a more widely accessible network (114) such as the internet, a telecommunications network or some other form of public or private network. In this way, the results of the different variant approaches herein can be made available to, for example, terminals (116) and specialized order entry systems (118) of an exchange or trading floor (120), persons of interest using a wireless handheld device like a smartphone (122), personal computers (124), or to terminals typical for the financial industry (126). Of course, depending upon the particular implementation, a device (128) which could be any of the foregoing types of devices (116, 118, 122, 124) could directly connect to the currency analysis processing system (100), the exchange system (106), and/or the currency transaction data processing system (108), the particular device or mode of connection details being both conventional and unimportant to understanding or use of the variants described herein.

Having described various physical components that can be used to implement or use numerous variant approaches as a backdrop, details about the various variants of the approaches themselves will now be discussed.

### Determining the Commodity Currencies

In overview, the process starts with a selected set of net commodity exporting countries, or some subset thereof. Depending upon the particular implementation variant, that set could potentially include, for example, any one or more of the following, non-exhaustive, nonlimiting, commodity exporting countries: Argentina, Australia, Bangladesh, Bolivia, Brazil, Burundi, Cameroon, Canada, Central African Republic, Chile, Colombia, Costa Rica, Cote d'Ivoire, Dominica, Ecuador, Ethiopia, one or more Eurozone (Euro) countries, Ghana, Guatemala, Honduras, Iceland, India, Indonesia, Japan, Kenya, Madagascar, Malawi, Malaysia, Mali, Mauritania, Mauritius, Mexico, Morocco, Mozambique, Myanmar, Norway, New Zealand, Nicaragua, Niger, Norway, Pakistan, Papua New Guinea, Paraguay, Peru, Philippines, Russia, Senegal, South Africa, Sri Lanka, St. Vincent and Grenadines, Saudi Arabia, Sudan, Suriname, Sweden, Switzerland, Syrian Arab Republic, Tanzania, Thailand, Togo, Tunisia, Turkey, Uganda, United Arab Emirates, United Kingdom, Uruguay, Zambia, or Zimbabwe, provided that the currency had sufficient liquidity. Note that, due to the fact that the Euro is a regional currency, the Eurozone can be treated in aggregate as a “country” as that term is used herein, as can one or more of the constituent members provided, where this is the case, the specific information for the desired Eurozone member(s), not the aggregate Eurozone numbers, are used.

With the approach described herein, since the intent is to minimize or neutralize the U.S. dollar bias, currencies pegged to the U.S. dollar, for example, those of Dominica, Saudi Arabia, St. Vincent and Grenadines, and the United Arab Emirates would generally not be included. However, some variants could include one or more such entities if the impact of the fixed currency conversion was unimportant for the particular instance, for example due to a relationship to other members that could comprise the ultimate basket, or because there is no way to meaningfully exclude such a country or exclusion would cause an unwanted alternative bias.

Depending upon the particular intended implementation, countries with net commodity exports can be selected, or, more narrowly, net commodity exporters of one or more specific commodities can be selected. For purposes of illustrative example only, a subset of nine developed countries will be the starting point, with no particular commodity or commodities being singled out as a subset of all exported commodities. Those countries (and associated currency designators) are: Australia (AUD), Canada (CAD), the Eurozone (EUR), Japan (JPY), New Zealand (NZD), Norway (NOK), Sweden (SEK), Switzerland (CHF) and the United Kingdom (GBP). From among these candidates, a determination can be made as to which, if any, should not be included in the ultimate basket of exporters.

Based upon the selection and specific commodity subset (if any), the approach begins with a determination of the discrepancy between trade and correlation bias for each. This is because the dollar influence on correlations shows up in a discrepancy between trade and correlation bias. According to this approach then, to minimize or neutralize the dollar influence, if either the trade vs gross domestic product (“GDP”) or the historical currency performance relative to the Commodity Research Bureau (“CRB”) index is negative, those country currencies are excluded. Alternatively, a threshold negative value can be used, such that as long as the negative value is not greater than the threshold, the currency can be included. The former approach tends to neutralize the dollar influence, while the latter would only minimize it.

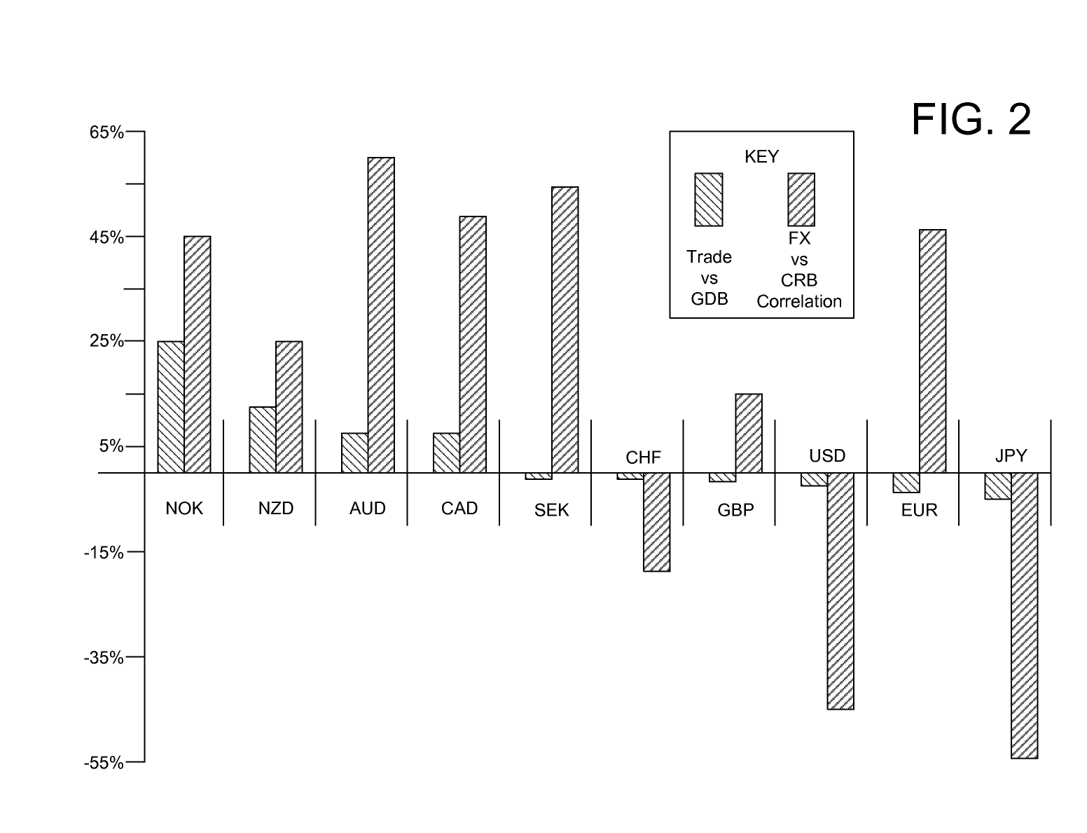

By way of example using the above nine countries, FIG. 2 is a chart showing net trade in commodities as a percent of GDP for those developed countries and for the United States, on average for the five years ending 2005, based upon the International Trade Centre's disaggregated trade data, which is generally available via the internet from the International Trade Centre at intracen dot org/tradstat/sitc3-3d/index_products.htm. Specifically in FIG. 2, for each country, the bar on the left shows trade relative to GDP and the bar on the right shows historical currency performance relative to the Commodity Research Bureau (CRB) index and, for simple illustration only, the chart is organized from left to right based upon ranking by trade.

As can be seen from FIG. 2, four of the countries that show up as commodity exporters (Norway, New Zealand, Australia and Canada) are all countries generally characterized as having “commodity currencies.”

While all commodity exporters have a positive correlation with the CRB index, the correlation for commodity importers is not always negative. For example, the Eurozone, has a high positive correlation with commodity prices, even though it is a large net importer.

Based upon this analysis, for the example countries, it is determined that only Norway, New Zealand, Australia and Canada will be included. Note that, had a different variant with an appropriate threshold been used, Sweden may have also been included. Thus, the basket will be made up of long positions in the AUD, CAD, NOK and NZD.

### Determining Weightings

Now that it has been determined that the basket will be comprised of long positions in AUD, CAD, NOK and NZD, the process continues with a determination of the weights for each.

Since it is desired to create a basket that is a broad indicator of the macro impact of commodities in the relevant global economy, three specific factors are used. The first is the relative importance of commodities for each of the basket countries. This is indicated by the relative size of the ratio of net commodity trade to GDP. In the case of the four countries noted above, this is shown in FIG. 2. The second factor is relative importance of each country in the global economy. This is proxied by the size of GDP. Finally, so as not to ignore the direct sensitivity of currency performance with commodities, relative correlation with the CRB is used.

Using the example countries of FIG. 2, the approach creates a basket that is long the four exporters, with the short restricted to the U.S. dollar. Another way to look at this is that a non-dollar based investor in commodities is implicitly long dollars because of how commodities are denominated. By making the basket long commodity linked currencies and short the U.S. dollar, the basket effectively minimizes or neutralizes the inherent long dollar position.

### Determining the Weights

### Commodity Importance Factor (“CF”) Weight

The weight (CF) that represents relative importance of commodities for each country is calculated according to Equation (1) as:

CFᵢ=(Net Commodity Trade)ᵢ/GDPᵢ (1)

where, for n total countries, GDPᵢ is the GDP of the particular country and (Net Commodity Trade)ᵢ is the net trade in the particular commodity or group of commodities, for example, as available from the International Trade Centre (at intracen <dot>org).

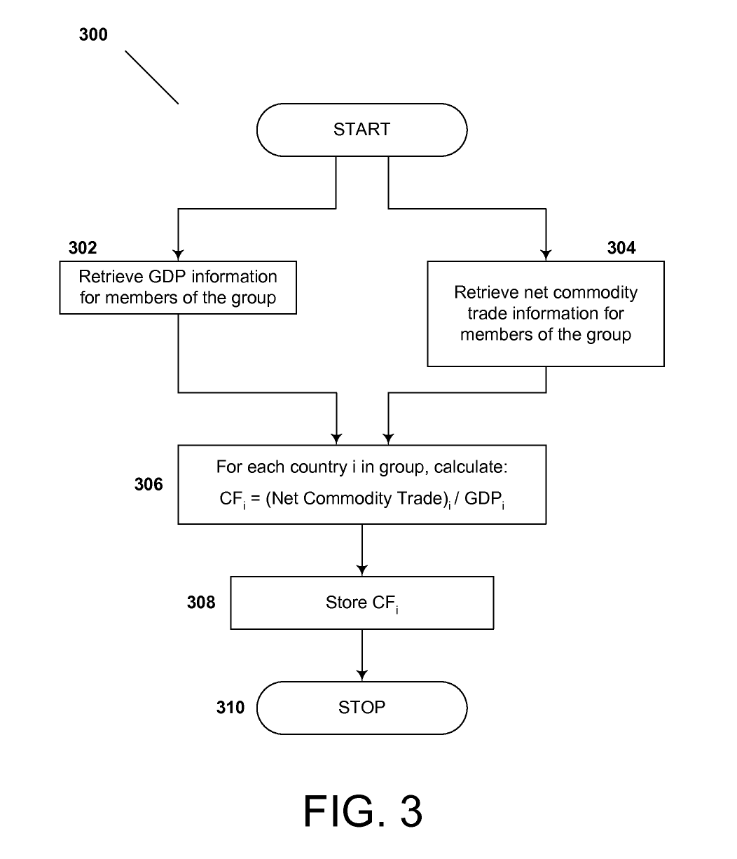

The general process flow for this calculation is shown in FIG. 3. The process 300 begins with the retrieval of the GDP information and Net Commodity Trade information for each country (Step 302, Step 304). Since these retrievals are order and time independent, to reflect this independence, the retrievals are shown in parallel. Next, the weight CF for each country i is calculated according to Equation (1) above (Step 306). Then the weights are stored (Step 308). When all the weights CF for all the countries i are stored, this phase is complete (Step 310).

### Global Economic Importance Factor (“GE”) Weight

The weight (GE) that represents relative importance of each country i in the global economy (as defined by the group of countries) is calculated according to Equation (2) as:

GEᵢ=GDPᵢ/ΣGDP_{i to n} (2)

where, for n total countries, GDPᵢ is the GDP of the particular country and ΣGDP_{i to n} is the sum of the GDP's of each of the members of the group.

It should be understood that since the sum of the GDP information is also used, it can be determined, as each individual country's information is obtained (a running total) or after all have been obtained. The particular process used to obtain the total is irrelevant to the invention.

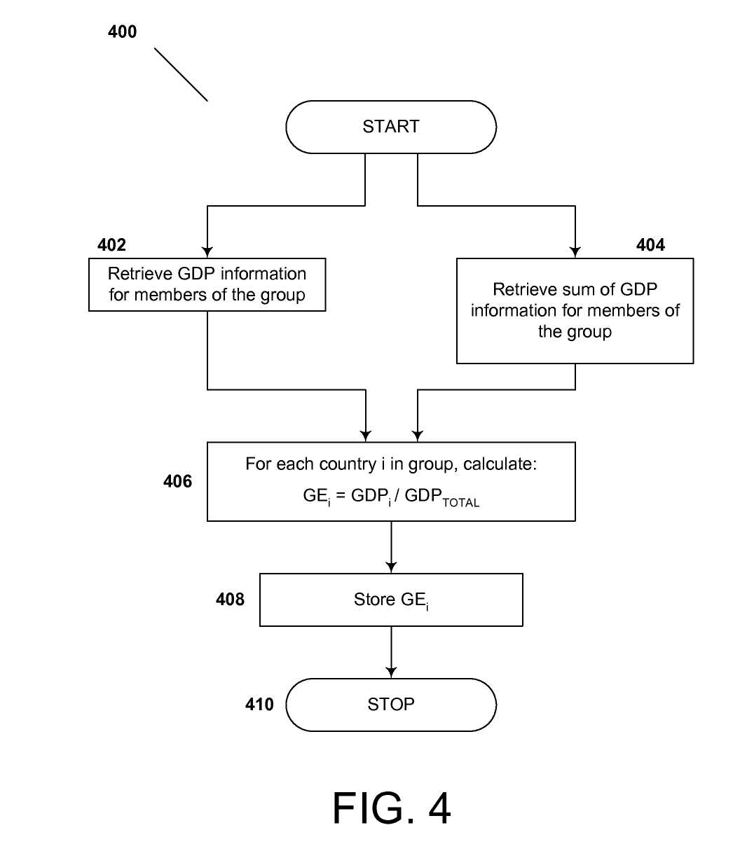

The general process flow for this calculation is shown in FIG. 4. The process 400 begins with the retrieval of the GDP information for each country (Step 402, Step 404). Then the sum of the GDPs is calculated or retrieved, if previously calculated. Next, the weight GE for each country i is calculated according to Equation (2) above (Step 406). Then the weights are stored (Step 408). When all the weights GE for all the countries i are stored, this phase is complete (Step 410).

Correlation with CRB Factor (COR) Weight The third weighting factor COR is based upon correlation with the CRB using a historical look back, for example, for prior five prior years. Note, the individual country CRB correlation information is the same as used for the selection described in connection with FIG. 2.

This factor COR is calculated according to Equation (3) as:

CORᵢ=CRBᵢ/ΣCRB_{i to n} (3)

where, for n total countries, CRBᵢ is the CRB correlation for the particular country and ΣCRB_{i to n} is the sum of the CRB correlation's of each of the members of the group.

Here too, it should be understood that since the sum of the CRB information is also used, it can be determined, as each individual country's information is obtained (a running total) or after all have been obtained, the particular totaling process being irrelevant to the invention.

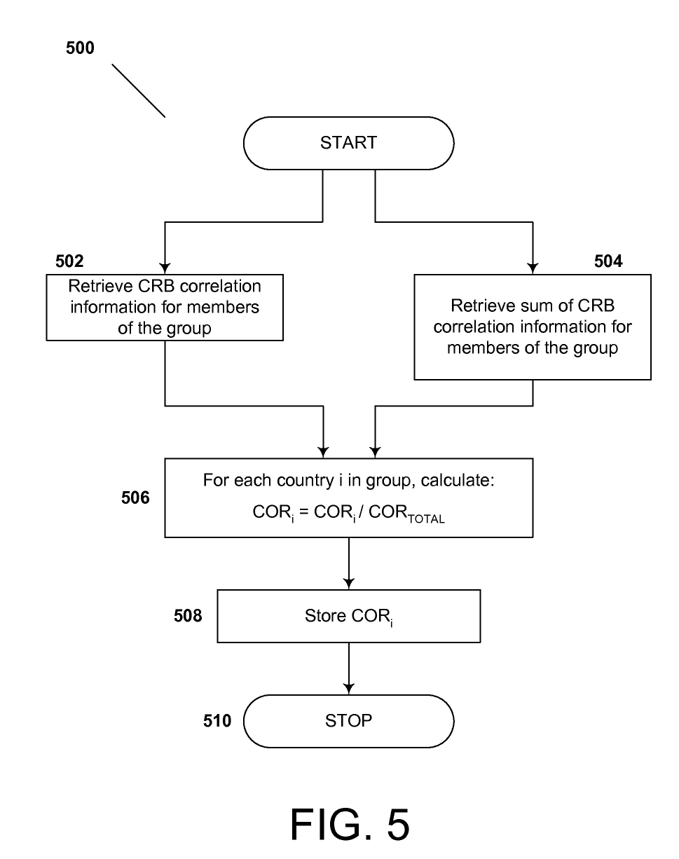

The general process flow for this calculation is shown in FIG. 5. The process 500 begins with the retrieval of the CRB information for each country (Step 502, Step 504). Then the sum of the CRB information is calculated or retrieved, if previously calculated. Next, the weight COR for each country i is calculated according to Equation (3) above (Step 506). Then the weights are stored (Step 508). When all the weights COR for all the countries i are stored, this phase is complete (Step 510).

### Portfolio or Index Determination

Once the individual weights CF, GE and COR for each of the members of the group have been determined, the overall weightings for each of the members of the group is calculated as the simple average of those weights for each country i according to Equation (5) as:

Wᵢ=(CFᵢ+GEᵢ+CORᵢ)/3 (5)

where the calculation is done for countries i=1, 2, . . . , n of the group.

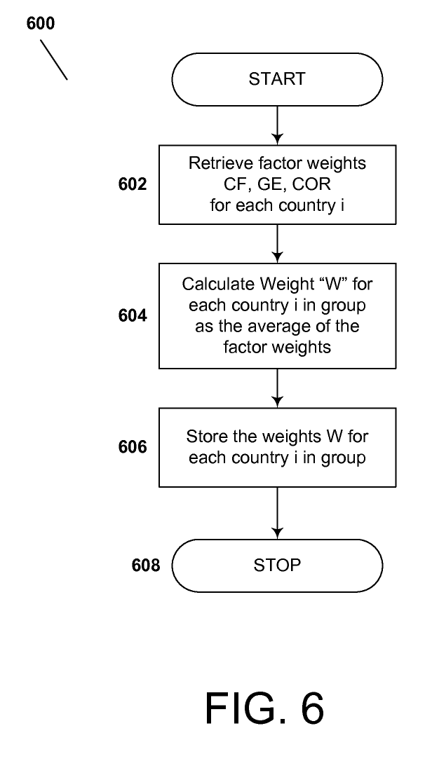

FIG. 6 illustrates, in simplified fashion, the general process flow 600 for the overall weighting determination. First, the weights CF, GE and COR are retrieved from storage (Step 602). Then the weight W is calculated for each as described above (Step 604). Those weights W are then stored (Step 606) and the process is complete (Step 608).

The resulting values Wi through Wn will thereby define a portfolio of currencies that is a valid proxy for the commodity performance and minimizes or neutralizes the inherent dollar bias of being long commodities. In other words, it provides a proxy way to invest in the performance of the particular commodities via a currency proxy.

Table 1 shows the resultant factors and weights for the four countries of the above illustrative example in which the first column contains the currency indicator for each country i, the second contains the CF factor for each, the third contains the GE factor for each, the fourth contains the COR factor for each and the fifth contains the W factor for each. Note that, for purposes of illustration, the values in each column do not add to exactly 100% due to rounding.

TABLE 1

| i | CF | GE | COR | W |
|---|---|---|---|---|
| CAD | 14% | 49% | 28% | 30% |
| NOK | 50% | 13% | 25% | 29% |
| AUD | 14% | 33% | 34% | 27% |
| NZD | 23% | 4% | 13% | 13% |

Advantageously, as a result, once the portfolio is defined, additional steps can be taken. For example, an investor or institution can build a currency portfolio according to the resultant weightings. Alternatively, or additionally, using known techniques, hedging strategies can be employed involving, or relative to, the portfolio, including, for example, arbitraging against the CRB index. With some variants, the portfolio can be part of, or form, a managed account. Still further, financial instruments, including exchange traded funds, exchange traded notes, and various other types of derivative instruments can be constructed, in a known manner, for example, to mirror, or that are linked to the performance of, the portfolio.

At this point it should also be noted that, in some cases due to the commodity at issue or the relative values for a country relative to all of the countries in the group, the weighting of a given currency in a group could be so small as to potentially only be capable of having a negligible effect on the group that will make up the portfolio as a whole. In such a case, that currency could optionally be deemed a “nominal” currency for the portfolio. In general, a nominal currency will have a total weight W on the order of about 3% or less, and typically a weight of less than 1%. In such a case, depending upon the particular implementation, the nominal currency can be dropped from the portfolio, if it is sufficiently small, or if simple removal is a concern, its weighting can be accounted for in the portfolio through adjustment of the other member weights by, for example, distributing the nominal currency weight among the other currencies (equally or proportionately), in proportion to export of a particular commodity, or using some other approach.

Advantageously moreover, the weightings can be used to construct an index.

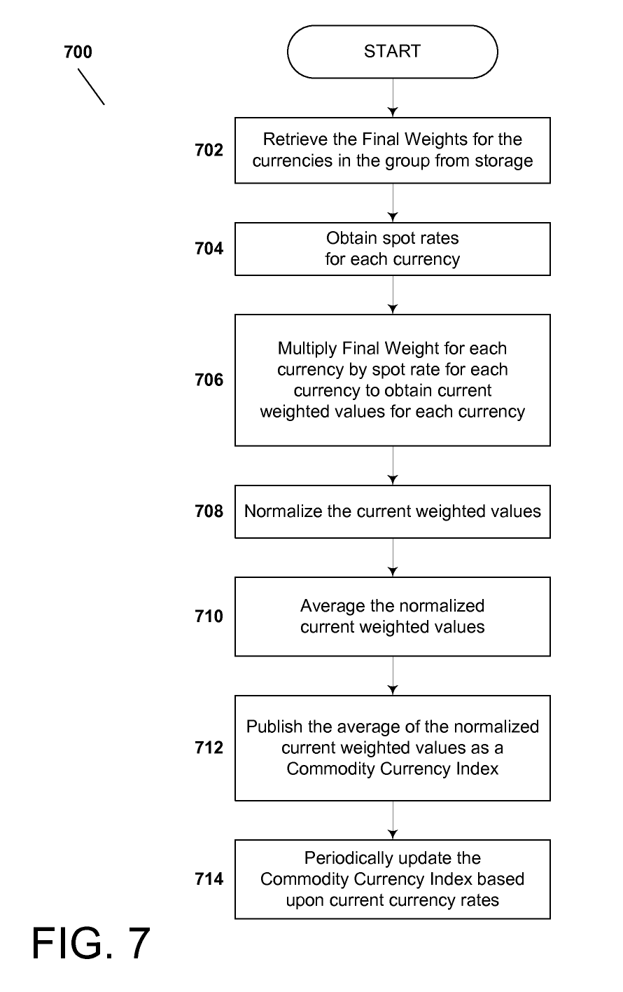

FIG. 7 illustrates, in simplified fashion, a flow diagram 700 for constructing an index using the weights. The process begins with retrieval of the final weights W for each of the members of the group (i.e. the resultant values from the process of FIG. 6) (Step 702). Next, spot rates are obtained for each of the currencies in the group (Step 704), for example, directly from a currency exchange or indirectly via a third party provider. Note that, as used herein, the “spot” rate is intended to encompass not only the then-actual instantaneous exchange value, but could alternatively be a forward price, an average price for a specified time period or some other price. In general, the prices will be continually available spot prices. However, to the extent that a given currency price is only quoted on longer time period basis, i.e. hourly, a few times a day, daily, weekly, etc., unless a historical calculation is being performed, the most recent price for each should be used. Next, the final weight for each currency in the group is multiplied by its corresponding spot rate (Step 706).

Each value obtained by multiplying the weight and price are then normalized to a common base (Step 708). There are numerous known approaches in mathematics and economics to accomplish this and the particular computation method will depend upon whether a return index, an absolute performance index or spot index is the intended end result. One simple example illustrative way is to establish a base date and calculate the percentage deviation between the date of concern and the base date. Another way is to treat the base date value for all of the members of the group as a fixed number, for example “100”, and scale everything subsequently by dividing the value on the date of concern by the value on the base date. For example, on the base date, if the value of one of the currencies in the group is 1.5 and the value of another of the currencies in the group is 1350, the base value of 100 would be obtained, for the first currency by multiplying it by 66.6667, and for the second currency by multiplying it by 0.0740. Thus, if on a subsequent date one currency is now 1.375 and another currency is 1500, their respective values for calculating the index would be calculated as (1.375×66.6667)=91.6667 and (1500×0.740)=111.1111.

The commodity currency index is then the arithmetic average of the normalized values (Step 710).

At this point, the index can be “published” (i.e. disseminated for viewing and/or use by the relevant public) (Step 712). Depending upon the particular variant, the index will thereafter be updated, on some periodic basis (Step 714) based upon the then-current rates for the currencies in the group, which could occur, for example, on a continuous basis (i.e. whenever any value changes) like the major equity indicies, it could be updated on a specific scheduled basis, such as every minute or hourly. It could be updated daily, like the Net Asset Valuation (NAV) calculations for mutual funds, or according to some other appropriate chosen scheme.

Again, once an index is created, financial instruments can be created that are based upon, or linked to the performance of, the index in a known manner. Alternatively, investment strategies can be employed that involve, for example, arbitraging the commodity currency index against the CRB index or other commodity indexes.

It should be understood that this description (including the figures) is only representative of some illustrative embodiments. For the convenience of the reader, the above description has focused on a representative sample of all possible embodiments, a sample that teaches the principles of the invention. The description has not attempted to exhaustively enumerate all possible variations. That alternate embodiments may not have been presented for a specific portion of the invention, or that further undescribed alternate embodiments may be available for a portion, is not to be considered a disclaimer of those alternate embodiments. One of ordinary skill will appreciate that many of those undescribed embodiments incorporate the same principles of the invention as claimed and others are equivalent.

What is claimed is:

1. A computerized method comprising:
determining, using a processor, a first currency weighting factor for each individual country in a group of net commodity exporting countries as a function of individual country net commodity trade information, obtained from storage associated with the processor, relative to individual country GDP information obtained from the storage;
determining, using the processor, a second currency weighting factor for each individual country based upon its GDP information, obtained from the storage, relative to total GDP information for the group;
determining, using the processor, a third currency weighting factor for each of the individual countries, based correlation to the Commodity Research Board index; and
calculating, for each of the individual countries, using the processor, a currency weight factor as an average of the first currency weighting factor, second currency weighting factor and third currency weighting factor, wherein the calculated currency weight factors for the group collectively defines a currency portfolio that is a proxy for at least some commodities exported by the countries of the group.

2. The method of claim 1, further comprising:
selecting, as a member of the group, at least one of Argentina, Australia, Bangladesh, Bolivia, Brazil, Burundi, Cameroon, Canada, Central African Republic, Chile, Colombia, Costa Rica, Cote d'Ivoire, Dominica, Ecuador, Ethiopia, a Eurozone member (Euro) country, Ghana, Guatemala, Honduras, Iceland, India, Indonesia, Japan, Kenya, Madagascar, Malawi, Malaysia, Mali, Mauritania, Mauritius, Mexico, Morocco, Mozambique, Myanmar, Norway, New Zealand, Nicaragua, Niger, Norway, Pakistan, Papua New Guinea, Paraguay, Peru, Philippines, Russia, Senegal, South Africa, Sri Lanka, St. Vincent and Grenadines, Saudi Arabia, Sudan, Suriname, Sweden, Switzerland, Syrian Arab Republic, Tanzania, Thailand, Togo, Tunisia, Turkey, Uganda, United Arab Emirates, United Kingdom, Uruguay, Zambia, or Zimbabwe.

3. The computerized method of claim 1, further comprising:
normalizing the currency weight factors for each individual country in the group; and
averaging the normalized currency weight factors, wherein the average of the normalized currency factors is a commodity currency index.

4. The method of claim 3, further comprising:
creating a financial instrument linked to performance of the regional currency index.

5. The method of claim 3, further comprising:
creating a financial instrument having a composition that substantially corresponds to a composition of the commodity currency index.

6. The method of claim 3, further comprising:
publishing the commodity currency index.

7. An apparatus for generating a commodity currency index, the apparatus comprising:
a currency transaction data processing system including at least one processor and storage, accessible by the processor, the storage including instructions which when executed by the at least one processor will cause the currency transaction data processing system to repeatedly:
multiply spot rates for a defined group of currencies of individual net commodity exporting countries by currency weight factors for each member of the defined group, the currency weight factors having been obtained from the storage and having been previously calculated as an average of at least three factors, wherein one of the at least three factors involves a comparison of individual country net commodity trade information relative to individual country GDP information, in order to generate current weighted commodity currency values for each of the currencies in the defined group;
normalize the current weighted regional currency values to obtain normalized commodity currency values; and
generate the commodity currency index as an average of the normalized currency values.

8. The apparatus of claim 7, wherein:
another of the currency weight factors obtained from the storage resulted from analysis performed in the currency transaction data processing system indicative of relative economic size of each of the members of the group relative to the group as a whole.

9. The apparatus of claim 7, wherein the currency transaction data processing system further comprises:
an exchange system configured to
receive bids and offers for a financial instrument linked to the commodity currency index, and match the received bids and offers for the financial instrument.

10. An apparatus comprising:
a processor;
storage, accessible by the processor;
first programming in the storage, executable by the processor, to compute country-specific factors for a set of net commodity exporting countries, on an individual country basis, based upon at least individual country net commodity trade information relative to individual country GDP information and individual country GDP information relative to total GDP information for the set of net commodity exporting countries;
second programming in the storage, executable by the processor, to compute country-specific weightings based upon a combination of the country specific factors for each of net commodity exporting countries in the set, on an individual country basis, and store results of the computation as a set of weightings for the countries in the set; and
third programming in the storage, executable by the processor, comprising an index generation module configured to convert the set of weightings and individual spot currency prices for the specific currencies into a commodity currency index, publish the commodity currency index, and periodically update the commodity currency index.

11. The apparatus of claim 10, further comprising:
an exchange system configured to
receive bids and offers for a financial instrument linked to the regional currency index and match the received bids and offers for the financial instrument.

12. A computer readable medium having instructions stored thereon which, when executed by a computing device, cause the computing device to:
determine a first currency weighting factor for each individual country of a group of net commodity exporting countries based upon individual country net commodity trade information relative to individual country GDP information;
determine a second currency weighting factor for the individual countries in the group based upon individual country GDP information relative to total GDP information for the group;
determine a third currency weighting factor for the individual countries in the group based upon correlation between each individual country in the group's currency and the CRB index; and
calculate a currency weight factor for each of the individual countries as an average of the first currency weighting factor, second currency weighting factor and third currency weighting factor.

13. The computer readable medium of claim 12, further comprising additional instructions stored on the computer readable medium which, when executed by the computing device, will generate a commodity currency index based upon the currency weight factors and spot prices for currencies to which each currency weight factor pertains.

14. The computer readable medium of claim 13, further comprising further instructions stored on the computer readable medium which, when executed by the computing device, will normalize results of combining the currency weight factors and spot prices.
